(19) United States
(12) Patent Application Publication
(10) Pub. No.: US 2006/0146825 A1
(43) Pub. Date: Jul. 6, 2006

(54) Network based quality of service

(75) Inventors: Christian Hofstaedter, Hellertown, PA (US); Christopher Bogdon, Cranberry Township, PA (US)

Correspondence Address: GREENBLUM & BERNSTEIN, P.L.C., 1950 ROLAND CLARKE PLACE, RESTON, VA, 20191, US

(73) Assignee: PADCOM, Inc., Bethlehem, PA (US)

(21) Appl. No.: 11/099,602

(22) Filed: Apr. 6, 2005

Related U.S. Application Data
(60) Provisional application No. 60/640,046, filed on Dec. 30, 2004.

(51) Int. Cl. H04L 12/28

(52) U.S. Cl. 370/392

(57) ABSTRACT

A quality of service routing method operates within a system including multiple parallel dissimilar wireless networks connecting a client device and a host device. The method includes selecting one of the networks based upon criteria, including priority, of a packet received from a source application. The method also includes routing the packet between the client device and the host device across the selected network, the source application being unaware of the network selected for the packet.

### CROSS REFERENCE TO RELATED APPLICATION

This application claims the benefit of U.S. Provisional Application No. 60/640,046, filed on Dec. 30, 2004, the disclosure of which is expressly incorporated by reference herein in its entirety.

### BACKGROUND OF THE INVENTION

1. Field of the Invention

The present invention relates to the field of data communications. More particularly, the present invention relates to providing quality of service measures to network traffic when routing data over multiple networks.

2. Background Information

Advances in technology have impacted many areas of computer automation; for example, computer applications are becoming increasingly ‘intelligent’. Traditionally, applications were developed to operate as stand-alone entities. Applications like word processors, spreadsheets, or database applications were traditionally confined to a single computer with minimal methods for direct data sharing. Data could only be shared by exchanging floppy discs or other removable storage mediums. However, by leveraging these mediums, Users experienced problems with synchronizing the data when they wanted to collaborate or share documents. Specifically, how can the data be synchronized when data is copied to floppies and modified? In most cases, synchronization results in data being changed in two locations.

Local Area Networks quickly changed the course of events for sharing application data. Instead of having applications each storing their own data on their own PCs, computers were interconnected with each other. Therefore, the persistent storage of the data occurred on file servers or other machines. Applications became network aware and were therefore designed to inherently share the data. The sharing of data was accomplished using two methods. In a client-server mode, applications would send a request and then the servers would respond with the appropriate data. In a batch mode, sharing occurred in batches where data would be synchronized at the end of a day or the end of a work shift.

As more applications were designed to facilitate the sharing of data, and networks improved, applications relied on networks more. Networking infrastructures like gigabit Ethernet provided a very fast connection for applications. Since many people realized the advantages of using network connections while stationary (i.e., connected to a physical LAN), they also began to see the advantages of network connections while in a mobile environment. Wireless networks are increasing in speed and provide developers with better opportunities for adding new services to applications. In addition, because of the power of performing work on the go, users began to request new types of applications: real time communication systems.

While traditional applications did not require a link in real time, new applications are being and have been developed that require constant streaming of data to mobile users. Applications like Voice over IP require a continuous stream of data packets between a mobile worker and the servers. In addition, applications like video surveillance, music, and movie broadcasts also require a constant stream of data. In traditional non-time-sensitive applications, if a packet is delayed due to network congestion or it is lost or corrupted during network transmission, the application can simply request the packet again with no adverse effect. However, in real time environments, delaying a packet may have an adverse effect on the data quality. In time-sensitive applications (such as streaming media applications), delayed packets can cause unexpected and noticeable pauses in the transmissions and dropped packets can cause corruption in the data stream for the receiver. In either case, the result can be an unacceptable loss of quality such that the transmission itself loses all value.

While delayed or dropped packets is a natural occurrence in data communications, the problem becomes more consequential in time-sensitive applications. In addition, the issue is exacerbated when there are multiple applications vying for the network link at the same time. For example, if a user is downloading a full motion video stream while printing a large document to a network printer, the network connection can be saturated thereby incurring delayed or dropped packets. In this example, the solution is to allow the time-sensitive application traffic to have priority. In the above example, full motion video should have transmission priority so that its data is not delayed or lost, while the printing can have a lower priority. If packets are dropped in the non time-sensitive applications, there will be minimal impact. In many cases, this type of network prioritization is called Quality of Service (QoS).

The problem is more serious when there are multiple networks being used. While there exist methods for prioritizing network activity within a single network, there is no additional mechanism to provide application quality of service between different networks. In addition, there is no easy method to provide quality of service functionality to applications that were not already designed to support quality of service.

### SUMMARY OF THE INVENTION

In view of the foregoing, the present invention is directed to providing quality of service functionality for various applications when used over multiple networks, both wireless and wireline. The present invention, which may be embodied as network based QoS, allows a mobile data user to simultaneously and transparently communicate over multiple networks to a local area network or other mobile device while allowing certain data traffic to take priority over non-essential data traffic. Another aspect of the current invention gives users the ability to easily add quality of service functionality to applications without requiring costly source code changes.

According to an aspect of the present invention, a network-based quality of service routing method operates within a system including multiple parallel networks connecting a client device and a host device. The method includes routing a packet between the client device and the host device across one of the parallel networks. The network is selected based upon a priority assigned to the packet. In one embodiment, at least one other network is also selected, in addition to the first selected network, to transmit the packet based upon the priority. In the case of multiple packets having the same priority level, the packets may be routed over multiple selected networks, the selection being based upon the priority level.

In another aspect, a method is provided for propagating a QoS tag from an internal packet that is encapsulated by an outside packet to the outside packet. The method includes determining the QoS level of the internal encapsulated packet and setting the QoS level in the outside packet to the QoS level determined for the internal packet.

In yet another aspect, a method is provided for assigning a QoS value to a data packet based upon characteristics of the data packet, the data packet being received from a source application. The method includes determining whether the characteristics of the data packet match a user-defined criteria. When the characteristics of the data packet match the criteria, the method sets a QoS level within the packet. The QoS level was previously associated with the criteria by a user. Consequently, the packet is assigned the QoS level without processing by the source application.

In an aspect of the invention, a quality of service routing method operates within a system including multiple parallel dissimilar wireless networks connecting a client device and a host device. The method includes selecting one of the networks based upon criteria, including priority, of a packet received from a source application. The method also includes routing the packet between the client device and the host device across the selected network, the source application being unaware of the network selected for the packet.

The method may also include selecting at least one other network, in addition to the first selected network, to transmit the packet based upon the packet priority, and routing the packet over multiple selected networks.

In one embodiment, the selected network is a default network. The selected network may also be at least one alternate network. In this case, when multiple alternate networks are selected, the networks are listed in a priority order. The criteria can include at least one of a port, protocol, and an IP address.

The method can also include receiving at least one additional packet; and analyzing criteria, including priority, of the at least one additional packet. When the criteria matches predefined criteria, the at least one additional packet is discarded without transmitting the at least one additional packet.

In another aspect of the present invention, a method is provided for propagating a QoS tag from an internal packet that is encapsulated by an outside packet to the outside packet. The method includes determining a QoS level of the internal encapsulated packet; and setting the QoS level in the outside packet to the QoS level determined for the internal packet.

In still another aspect, a method is provided for assigning a QoS value to a data packet based upon characteristics of the data packet, the data packet being received from a source application that operates within a system including multiple parallel dissimilar wireless networks connecting a client device and a host device. The method includes determining whether the characteristics of the data packet match a user-defined criteria; and setting a QoS level within the packet when the characteristics of the data packet match the criteria. The QoS level was previously associated with the matched criteria by a user. Consequently, the packet is assigned the QoS level without processing by the source application.

In yet another aspect, a system assigns quality of service tags to data received from a source application without processing by the source application. The system operates with dissimilar, parallel wireless networks connecting a client device and a host device, and with data that is routed between the client device and the host device across selected networks while the source application is unaware of the networks selected. The system includes a partner process that receives data from the source application, and a QoS system. The QoS system receives data from the partner process and analyzes the data to determine whether the data matches criteria. The QoS system assigns a quality of service tag, associated with matching criteria, to the data. The QoS system also returns the data and quality of service tag information to the partner process. The criteria can include a port, protocol, and/or an IP address.

In another aspect, a system is provided for assigning quality of service tags to data received from a source application without processing by the source application. The system includes a routing process that receives data from the source application and selects multiple wireless networks for transmitting the data. The wireless networks are dissimilar, parallel, and connect a client device and a host device. The routing process routes the data between the client device and the host device across the selected networks with the source application being unaware of the networks selected. The system also includes a QoS system that receives data from the routing process and analyzes the data to determine whether the data matches criteria. The QoS system assigns a quality of service tag, associated with matching criteria, to the data when the criteria is matched. The QoS system returns the quality of service tag information and the data to the routing process for routing.

In one embodiment, the routing process selects the networks based upon the quality of service tag information. The QoS system can also analyze the data to determine whether the data matches criteria including the quality of service tag. The QoS system selects at least one network for the data based upon the matching criteria and returns the data and a network indicator to the routing process. The routing process can also select the networks based upon the network indicator.

In yet another aspect, a system routes data based upon quality of service tags associated with data received from a source application. The system operates with dissimilar, parallel wireless networks connecting a client device and a host device. The data is routed between the client device and the host device across selected networks while the source application is unaware of the networks selected. The system includes a partner process that receives data from the source application, and a QoS system. The QoS system receives data from the partner process and analyzes the data to determine whether the data matches criteria including a quality of service tag. The QoS system selects at least one network for the data based upon matching criteria, and returns the data and a network indicator to the partner process. The criteria can be a port.

In a further aspect, a system routes data based upon quality of service tags associated with data received from a source application. The system includes a routing system that receives data from the source application and routes the data over at least one wireless network selected based upon a network indicator associated with the data. The wireless network(s) are selected from dissimilar, parallel wireless networks that connect a client device and a host device. The routing system routes the data between the client device and the host device across the selected network(s) while the source application remains unaware of the network(s) being used. The system also includes a QoS system that receives data from the routing system and analyzes the data to determine whether the data matches criteria including a quality of service tag. The QoS system selects at least one network for the data based upon matching criteria, and returns the data and the network indicator to the routing system.

In one embodiment, the network indicator indicates a default network. The network indicator can also be at least one alternate network, so that when multiple alternate networks are indicated, the networks are listed in a priority order. The network indicator can indicates that the data is not to be sent, in which case the routing system does not send the data.

### BRIEF DESCRIPTION OF THE DRAWINGS

The present invention is further described in the detailed description that follows, by reference to the noted drawings by way of non-limiting examples of preferred embodiments of the present invention, in which like reference numerals represent similar parts throughout several views of the drawings, and in which:

FIG. 1 illustrates a schematic block diagram of various components of a network based QoS system, according to an aspect of the present invention;

FIG. 2 illustrates a block diagram that depicts where the network based QoS system can be located relative to the mobile devices, according to an aspect of the present invention;

FIG. 3 illustrates a block diagram that depicts software components, in accordance with an aspect of the present invention;

FIG. 4 illustrates another block diagram of the network based QoS system, according to an aspect of the present invention;

FIG. 5 illustrates an exemplary configuration screen, according to an aspect of the present invention;

FIG. 6 illustrates an example of a configuration screen that displays rules that are entered within the system, according to an aspect of the present invention;

FIG. 7 illustrates an example of a configuration screen for adding a new rule into the system, according to an aspect of the present invention;

FIG. 8 illustrates an example of a configuration screen for adding a network QoS entry, according to an aspect of the present invention;

FIG. 9 illustrates an example of a configuration screen for adding a network QoS rules based routing entry, according to an aspect of the present invention;

FIG. 10 shows an example of the internal map data structure for storing rule definitions, according to an aspect of the present invention;

FIG. 11 shows an example of an IP header and determines which entries are used for specifying the QoS values within the packet, according to an aspect of the present invention; and

FIG. 12 shows an example of IP packet encapsulation and QoS Propagation, according to an aspect of the present invention.

### DETAILED DESCRIPTION

Network based QoS functionality provides network administrators with added control over the data that flows over networks. While in certain cases, a mobile user will be using a single network; in many cases multiple wireless networks will be leveraged. To achieve an optimum multi-network experience, a mobile user should be able to seamlessly roam between different wireless networks using a wireless router. An exemplary router is described in U.S. Pat. No. 6,198,920, to DOVIAK et al., issued Mar. 6, 2001; U.S. Pat. No. 6,418,324, to DOVIAK et al., issued Jul. 9, 2002; and U.S. Pat. No. 6,826,405, to DOVIAK et al., issued Nov. 30, 2004, the disclosures of which are expressly incorporated by reference herein in their entireties.

Network based QoS builds upon the function of tagging application data traffic. QoS tags have existed since the early days of network design. The first description of the IP protocol included a field called “precedence” which serves as the basis for QoS tagging. Routers and other infrastructure devices interpret these tags to represent a priority value for the particular packet. As the packet flows through the network, the packet has priority through the network intermediary point if its tagged value is higher than other data.

Basic network tagging has been around for a long time, however, historically it has been the responsibility of the application developer to build support for the tags within their application. One aspect of this invention provides system administrators a user interface. One embodiment of the user interface may be a user-friendly graphical user interface (GUI) although other possibilities such as command line interfaces (CLI), configuration files, and programmatic APIs are possible as well. The system administrator may employ the user interface to define rules that, when matched for a packet emitted from an application, will allow tags to be imposed on that application traffic. This functionality occurs after the packet is emitted by the application and so is transparent to the application. Therefore, the applications do not have to be rewritten to support the addition of QoS tagging on the packets. This functionality has benefits for any type of application on any combination of networks since the system administrator can automatically choose which tags are used for which applications while not requiring costly application rewrites or application development.

Another feature of network based QoS provides QoS tag propagation. In many network applications, data encapsulation is used to communicate between a client and a server. Encapsulation is also known as “tunneling.” Encapsulation within the data communication industry is defined as the inclusion of one data structure within another structure so that the first data structure is temporarily hidden. For example, a TCP/IP-formatted data packet can be encapsulated within an ATM frame. Within the context of transmitting and receiving the ATM frame, the encapsulated packet is simply a stream of bits within the ATM data that describes the transfer. Many types of applications leverage encapsulation, including virtual private networks and network bridging apparatuses.

When using encapsulation, the original data packet may have certain characteristics that are lost when placed into the encapsulated data form. QoS tagging is an example of data that could be lost. If an application has tagged a packet with a high priority tag and that packet is subsequently encapsulated, the new header that is placed on the packet will not have the tag present. Therefore, network intermediaries have no way of determining the priority of the packet originally intended by the application. Therefore, the encapsulated packet will be routed according to a default priority. In addition, if the packet is encrypted, as through a VPN, the same problem occurs. The data priority of the packet is lost, and the packet is sent with a default level of priority.

Finally, network based QoS functionality can be used as criteria for routing data in a multiple network solution. In this example, a mobile user may be using two different networks in a multipathing format, e.g., as described in U.S. patent application Ser. No. 10/835,396, to HOFSTAEDTER et al., filed on Apr. 30, 2004, the disclosure of which is expressly incorporated by reference herein in its entirety, or in a prioritized port routing format as described in U.S. patent application Ser. No. 10/374,070, to HOFSTAEDTER et al, filed on Feb. 27, 2003, the disclosure of which is expressly incorporated by reference herein in its entirety, or in a broadcasting data over multiple dissimilar wireless networks format as described in U.S. patent application Ser. No. 10/967,130, to HOFSTAEDTER et al, filed on Oct. 20, 2004, the disclosure of which is expressly incorporated by reference herein in its entirety, or in a router environment as described in U.S. Pat. No. 6,198,920, to DOVIAK et al., issued Mar. 6, 2001; U.S. Pat. No. 6,418,324, to DOVIAK et al., issued Jul. 9, 2002; and U.S. Pat. No. 6,826,405, to DOVIAK et al., issued Nov. 30, 2004, the disclosures of which are expressly incorporated by reference herein in their entireties.

Criteria can be added that will allow the appropriate transmission type to be chosen based upon the QoS tags of the data. In a multipathing environment, it may be determined that voice over IP data packets should have a QoS tag of five. In addition, it may be determined that data with QoS tags of five should flow through the multipathing subsystem. Therefore, when the data is received at the router, the system will compare the tags with the pre-determined lists and the data will be automatically split over the multiple networks. In one embodiment, non-voice over IP traffic is not split using the multipathing subsystem. Therefore, its QoS tags will be set to a value different from five.

In addition, if the user is seamlessly roaming between the dissimilar networks, it may be worthwhile to specify that if the user is in range of a particular network, then only data with the appropriate QoS tag will flow over the appropriate network. If we take the previous example, it may be specified that any packets with a QoS tag of five should be constrained to Wireless LAN. Therefore, when the data is received at the router, the system will compare the tags with the rules and decide to route the priority five data over a specific network (i.e., Wireless LAN), while data without a QoS tag of five will be routed using any of the current networks.

Besides the alternate routing of data over networks as specified in this example, other decisions can be made based upon the QoS tags. Current examples include, “Ignore” (Drop any packets with the appropriate tag), “Alternate” (Route the packets with the appropriate tag over the secondary network, “Default” (Route the packets with the appropriate tag over the default network), “Multipath” (Route the packets simultaneously over multiple wireless networks via the Multipathing subsystem), “Multicast” (Route the packets to multiple clients via the Multicasting protocols), or “Broadcast” (Route the packets to all clients via transport network broadcast mechanisms). However, other types of actions can be incorporated in further embodiments of a network based QoS system. For example, a “Convert” rule could be added that would allow various aspects of the packet header or payload to be transformed prior to other routing mechanisms.

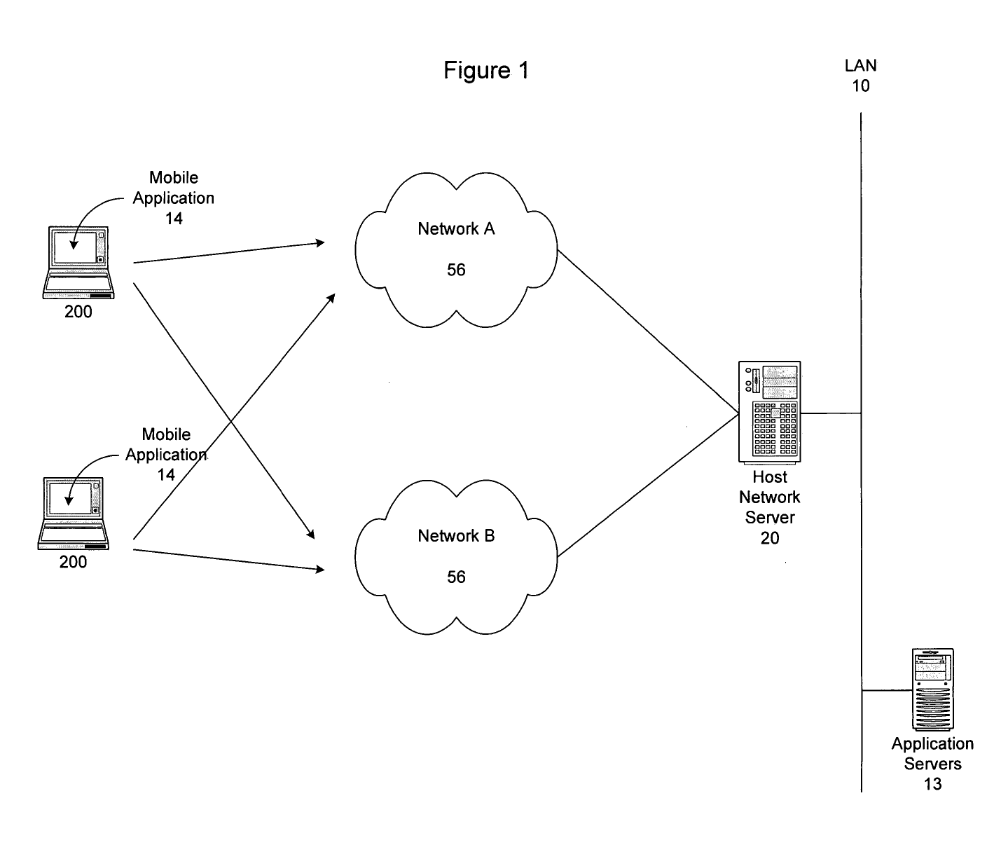

FIG. 1 outlines a typical architecture of a system that incorporates network based QoS functionality. Mobile devices 200 will be executing some type of application 14 that utilizes the network resources. The mobile devices are connected to one or more networks 56. These networks can be either wireless or wired. In addition, solutions implementing network based QoS also include a Host Network Server 20 and application servers 13 residing on a LAN 10. The Host Network Server 20 is responsible for ensuring that outbound data traffic (from the LAN 10 to the Mobile Users 200) will also be controlled by the network based QoS system.

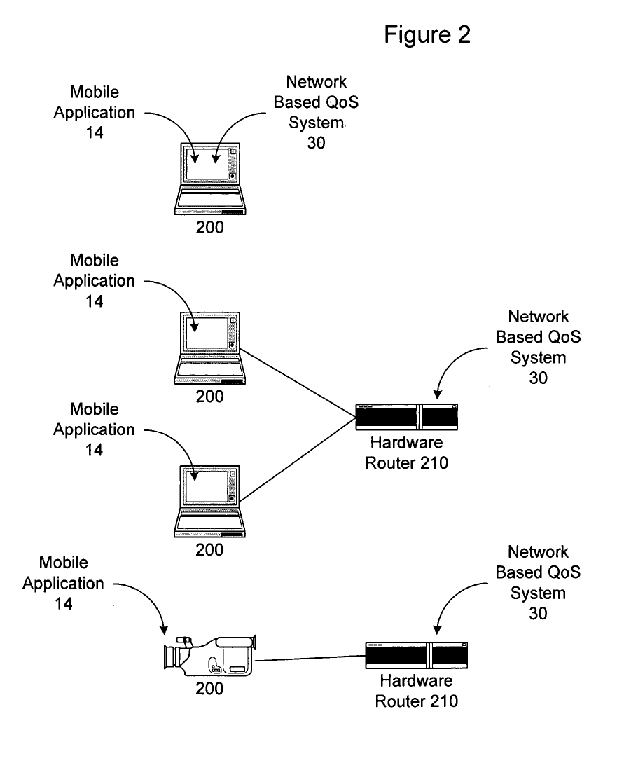

As shown in FIG. 2, the network based QoS application can reside at several different locations. The simplest example places the network based QoS system 30 and the mobile applications 14 on the same mobile computer 200. However, an alternative embodiment includes installations of the network based QoS system 30 on a Hardware Router 210. This arrangement permits applications on different devices, like cameras or multiple computers, to communicate using the network based QoS functionality. Although not demonstrated in a specific figure, the implementation may also take the form of hosting the router and/or the network based QoS system within a software defined radio or the firmware of any other communications device embedded as a component within the mobile computer or hardware router.

If the mobile devices are mobile computers, then exemplary applications may include streaming media applications (video, voice, stock tickers, etc.), database applications, client-server applications, messaging or dispatch applications, web browser clients, file transfer applications, or email clients. If the mobile devices are not mobile computers, then exemplary applications may include firmware that provides video surveillance or still pictures via streaming media, reads sensors and sends readings, or receives data from a host application to control a device.

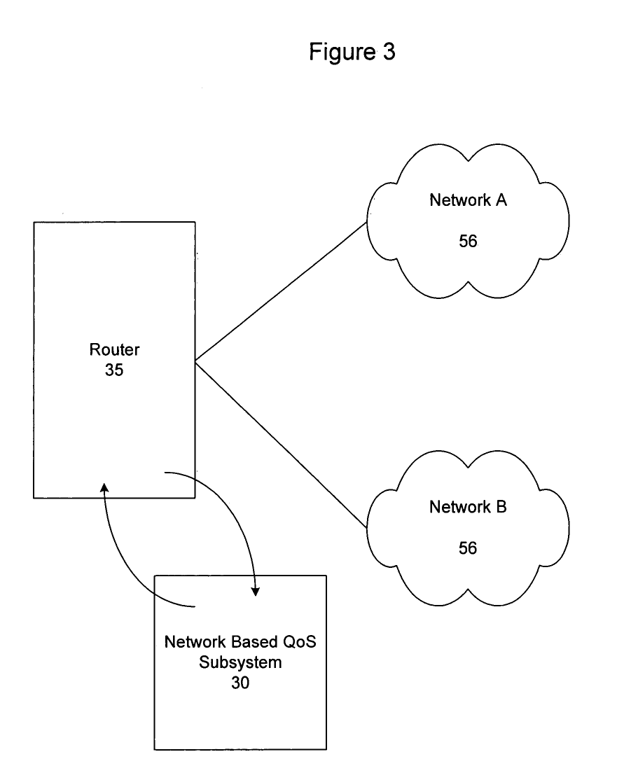

FIG. 3 shows an example of the communications between a partner process 35 (e.g., a router) and the network based QoS system 30. The network based QoS system 30 normally communicates with another process. This architecture allows the network based QoS system 30 to provide its functionality to virtually any other application platform. The communication link between the partner process 35 and the network based QoS system 30 is any type of Interprocess Communication (IPC) including, but not limited to, files in persistent storage, sockets, pipes, queues, DCOM, CORBA, or shared memory. In the example in FIG. 3, the network based QoS system 30 is communicating to a standard router 35. The router 35 can be used as a standard router; however, if certain traffic is required to be sent using the network based QoS system 30, then the data can be forwarded to the network based QoS system 30 for processing.

An alternative embodiment provides for the network based QoS system to operate transparently to either the host application or the mobile router by hooking into the IP stack of the mobile computer. In this scenario, the network based QoS system intercepts the packets prior to the mobile router, performs its processing modifying the packet as necessary (i.e., updating the QoS tag if the matching rule indicates that this should take place), and reintroduces the packet into the IP stack so that the mobile router may then intercept the packet and perform its services.

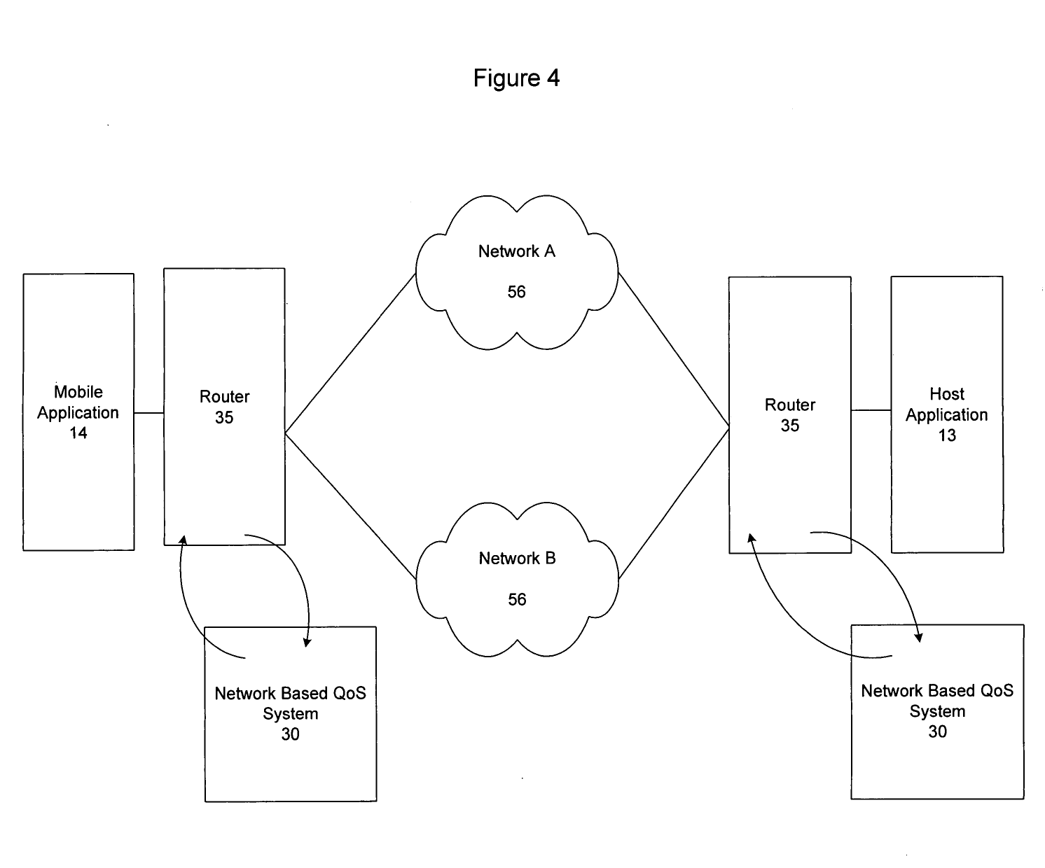

FIG. 4 expands the system by including mobile applications 14 and host applications 13 in conjunction with the network based QoS system 30. The network based QoS system 30 communicates with the router 35 by accepting packets from the router 35 and sending packets back to the router 35. Therefore, when packets flow through the router 35, the router 35 can decide whether the data should be processed using the network based QoS system 30. If so, the router 35 passes the data to the network based QoS system 30 for processing. Once the network based QoS system 30 finishes processing the data for transmission over the multiple networks 56, the network based QoS system 30 then passes the data back to the router 35 for the eventual delivery over the networks 56.

The network based QoS system can reside on the sender (e.g., mobile device) and the receiver (e.g., Host Network Server). Each network based QoS system will be responsible for processing outbound traffic. In this case, the Host Network Server is responsible for maintaining outbound communications to the mobile clients.

The network based QoS system requires a configuration interface to provide control to system administrators to alter the behavior of the network based QoS system. In an embodiment, this configuration interface is located on each system that includes the network based QoS system. An alternative embodiment specifies the configuration will be only entered on the Host Network Server, and the mobile clients will automatically learn the configuration options through the networks. This type of system has the advantage of reducing and centralizing the configuration required for the network based QoS system. In this example, the configuration screens for the mobile clients may only display an IP address that is used as a location to request the configuration of the system from.

A further refinement of the previous example would provide for the network based QoS system to share configuration settings with the mobile router. For example, the mobile router may already maintain an IP address from which to request its own configuration settings. This same IP address may be used by the network based QoS system. The system may use industry standard techniques like HTTP, FTP or TFTP or it may use proprietary techniques to download the configuration options from the centralized server. Regardless of what method is used to configure the system, the data is stored in persistent storage; exemplary types of storage include, but are not limited to hard disk drives, flash memory or relational databases. Alternatively, the configuration may only be stored on the Host Network Controller and not on the mobile computers thereby requiring that the network based QoS subsystem on the mobile computers acquire their configuration dynamically each time the system is started.

If the operating system on the machine provides a graphical user interface, the configuration can be performed using a graphical application residing on the host. As indicated previously, the configuration host may be either the Host Network Controller only, both the Host Network Controller and the mobile computer, or another host altogether. If the host on which the network based QoS system is installed or configured does not provide a graphical user interface, then some other means will be required to receive the configuration. One exemplary type is a configuration interface that receives configuration packets at a UDP port over the networks or accepts configuration via a download of a file. Another exemplary type is a command line interface (CLI).

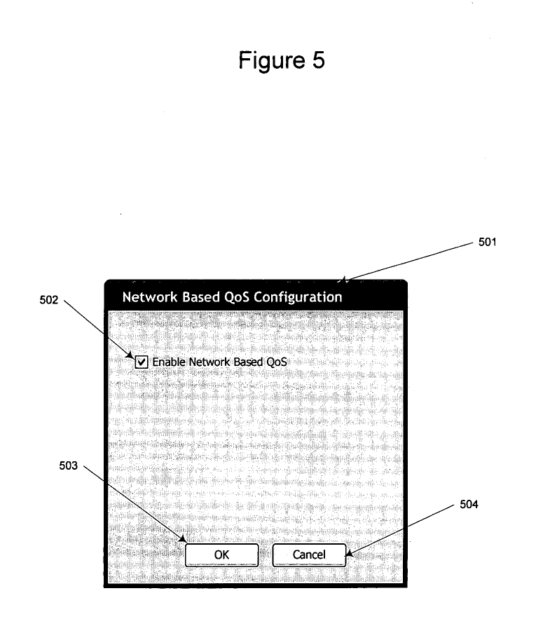

FIG. 5 shows a configuration screen 501 that allows the user to either enable or disable the network based QoS system. If the user checks the box 502, then the network based QoS functionality is enabled; otherwise it is disabled. The window also provides an OK button 503 to accept the change and a Cancel button 504 to cancel the changes. If an alternative embodiment is used to configure the network based QoS system, this screen may include an IP address and port number settings.

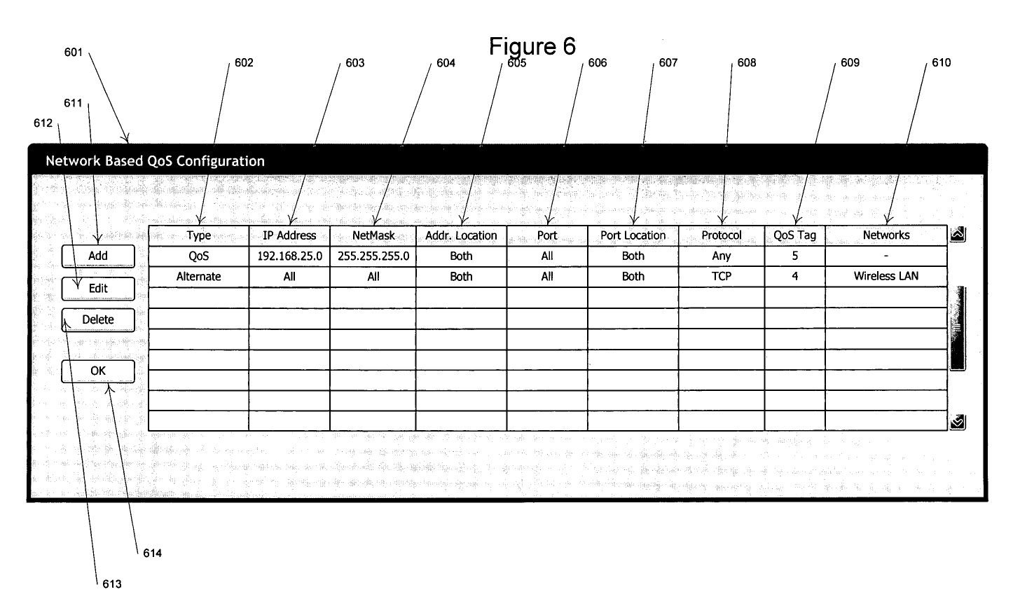

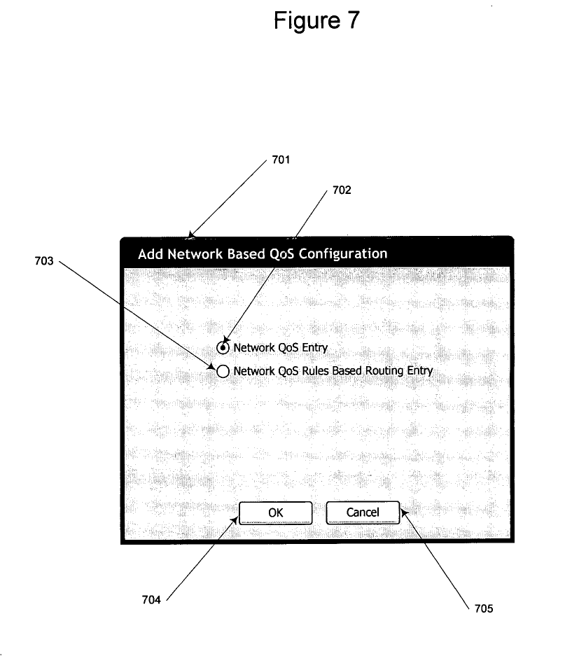

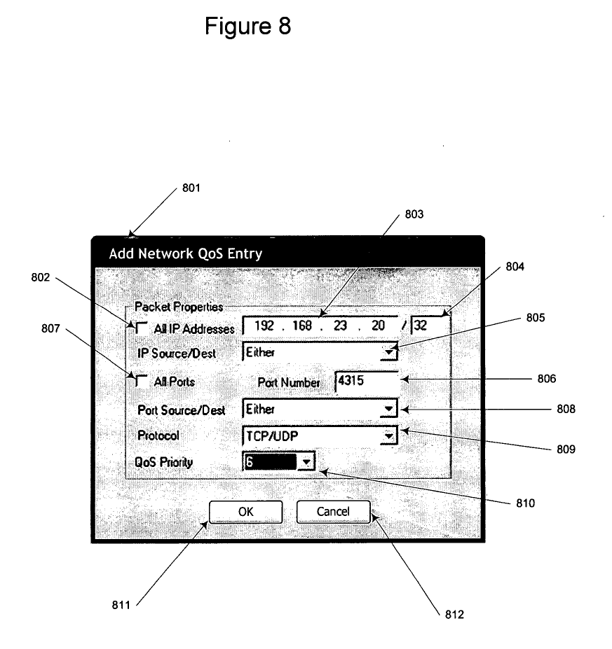

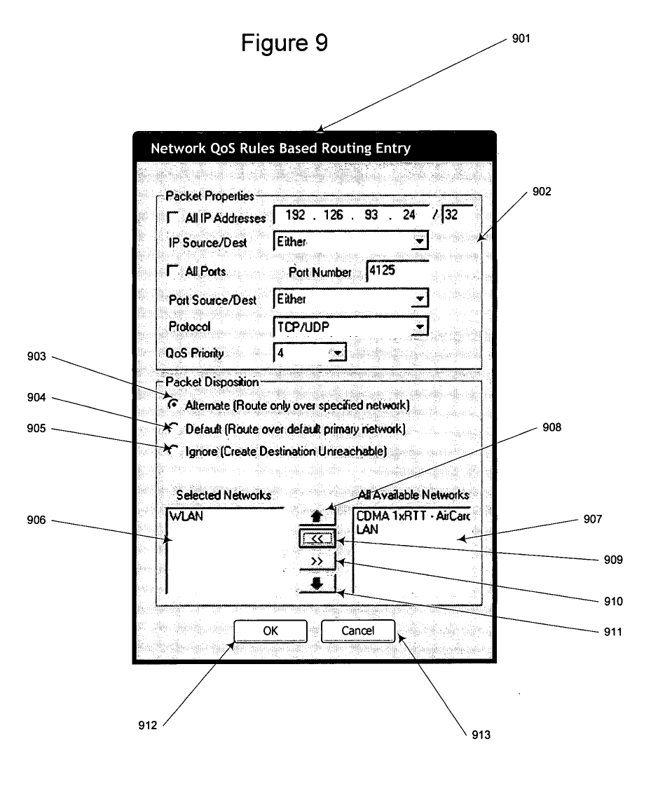

FIG. 6 shows an exemplary network based QoS Configuration table that displays each QoS configuration entry. This table uses a columnar format to display packet criteria. As packets flow in through the system, they are matched up against the criteria in this table. If the packets match, then the particular action specified in the type column is performed on the packet. The screen provides an Add button 611 to insert a new entry into the table. The Add button 611 brings up the screen depicted in FIG. 7 to prompt the user to select the type of record that should be added. The Edit button 612 is pressed anytime a user wants to edit an existing record which brings up the appropriate window displayed in FIG. 8 or 9 in edit mode. The Delete button 613 allows the user to delete an individual record within the table. Finally, the OK button 614 allows the user to accept all changes and save the data into persistent storage. In addition to the buttons, the Network Based QoS Configuration screen 601 also displays a table having the following fields:
Type 602—This type field displays the type of entry in the table. In one embodiment, there are four different types of records. ‘QoS’ states that the entry is a QoS tag which allows the system to add a QoS value to any packet that matches the criteria defined in the record. ‘Alternate’ specifies that the entry will route the data over the alternate networks listed in the Networks column 610 when they match the criteria defined in the record. ‘Default’ specifies that the entry will route the data over the current default network when they match the criteria defined in the record. ‘Ignore’ specifies that the entry will discard the packet when they match the criteria defined in the record.
IP address 603—This field lists any IP address used in the packet specification criteria.
NetMask 604—This field combined with the IP address will determine a range of IP addresses used in the packet specification criteria.
Address Location 605—This field indicates whether the matched IP address and NetMask combination should appear in the source or destination field of the IP header or whether the appearance in either field would represent a match.
Port 606—This field determines if a Port number should be used in the packet specification criteria.
Port Location 607—This field determines if the matched Port number appears in either the source or destination field within the IP header or whether the appearance in either field would represent a match.
Protocol 608—This field determines if a protocol should be used in the packet specification cirteria.
QoS Tag 609—This field lists the appropriate QoS tag. If the record is a ‘QoS’ record, this field represents the QoS value that will be assigned to the matching packet as it flows through the system. If the entry is not a QoS type, this QoS value will be used in the packet specification criteria.
Networks 610—This field lists the alternate networks that will be used for routing the packets that match the criteria specified in ‘Alternate’ record types.

Any time the user presses the Add button 611, the Add Network Based QoS Configuration screen 701 that is displayed in FIG. 7 will be displayed. This screen provides the user with the option to select the type of QoS configuration that should be added. A radio button 702 is provided to select Network QoS Entry and a radio button 703 is provided to select a Network QoS Rules Based Routing Entry. If the user presses the OK button 704, then the appropriate screen will be displayed. If the user presses the Cancel button, then the screen will clear and control is passed to the previous Network Based QoS Configuration window 601.

When the user attempts to create a Network QoS Entry by selecting the radio button 702, an Add Network QoS Entry screen 801, as depicted in FIG. 8, is displayed. This screen lists several fields which allow the user to build a packet criteria or packet identity. The goal is that once the criteria is specified, then any packet that matches the criteria will be assigned to the QoS Priority value set in the QoS Priority drop down list. This screen can have the following fields:
All IP Address 802—This setting uses IP addresses as the criteria.
IP Address 803—This setting will allow the user to specify an appropriate IP address as the matching criteria.
Subnet Mask 804—This setting will allow the user to specify the appropriate subnet mask as the matching criteria.
IP Source/Dest 805—This setting will allow the user to specify the location of the IP addresses. It determines if the IP addresses should appear in either the source or destination fields within the IP header. In addition, there is an option that allows the user to specify that it can appear in either location.
All Ports 807—This setting allows the user to specify whether Ports will be used as the criteria.
Port Number 806—This setting will allow the user to specify a specific Port number as one of the criteria.
Port Source/Dest 808—This setting will allow the user to specify whether the Port number should appear in the source, or destination fields within the IP header. In addition, there is a setting that allows the user to specify that it can appear in either location.
Protocol 809—This setting will allow the user to specify the protocol of the packet that will be used as the criteria. It is populated with the most prevalent protocols in network communications. These include, but are not limited to, TCP, UDP and ICMP.
QoS Priority 810—This value specifies the QoS Priority that is assigned to the packets that match the appropriate criteria defined above.

If the user presses the OK button 811, the settings will be saved into persistent storage. If the user presses the Cancel button 812, then the screen 801 will clear and control is passed to the previous Network Based QoS Configuration window 601 without saving the configuration.

When the user attempts to create a Network QoS Rules Based Routing Entry by selecting the Radio button 703, the Add Network QoS Rules Based Routing Configuration screen 901 as depicted in FIG. 9 will be displayed. This screen lists several fields 902 that are identical to the fields described with reference to the Add Network QoS Configuration Entry screen 801. The only exception is the QoS Priority field is now used as criteria for matching, as opposed to a value to be set within the matched packets. This configuration screen also adds a packet disposition section that describes the action to take whenever the appropriate packet is matched. In one embodiment, it contains the following three actions:
Alternate 903—This action specifies the packets that match the criteria are to be routed only over the networks that are selected within the Selected Networks window 906
Default 904—This action specifies the packets that match the criteria are to be routed only over the default network (i.e., whichever network is determined to be the current network)
Ignore 905—This action specifies the packets that match the criteria are to be ignored or dropped.

In addition to the above mentioned fields, the window also includes information regarding the selection of networks when the packet disposition is set to “Alternate”. The Selected Networks list 906 lists the appropriate networks that should be used. The All Available Networks list 907 shows all networks currently configured in the system. The user can press the “<<” button 909 to move networks from the All Available Networks list 907 to Selected Networks list 906 or press the “>>” button 910 to move the networks from the Selected Networks list 906 to the All Available Networks list 907. In addition, the user has the option of organizing the networks in the Selected Networks list box by pressing the up arrow button 908 and down arrow button 911. When the user selects multiple networks in the Selected Networks list 906, they will be listed in the priority that will be used. Therefore, if the first network is not available, then the second network will be chosen. Finally, if the user presses the OK button 912, the settings are saved. If the user presses the Cancel button 913, then the screen will clear and control is passed to the previous Network Based QoS Configuration window 601.

While this specification describes several items that can be used as criteria when matching data packets, the criteria can be expanded to include any type of criteria found within data packets. Other non-limiting examples of criteria include: packet size, fragmentation status, time to live, identification bytes, or payload contents. If the payload contents are used as criteria, regular expression matching or a similar mechanism could be used when evaluating the criteria. When matching such criteria against data that could reasonably contain binary data (such as a packet payload), the criteria will need to take this into account when it is displayed to the user for configuration purposes. One manner in which this could be taken into account would be to represent the criteria in a format such as hexadecimal. Even if the criteria were displayed to the user in such a manner, there would be no limitation on the actual storage format. This would allow the configured criteria to be stored in raw binary just as it would be used when evaluating the criteria at run-time. The system disclosed in this application can be extended to support these new criteria.

Process Flow

We will now describe an exemplary process flow of data through the network based QoS system.

Initialization

The first step to be performed upon startup of the network based QoS system is to determine the current configuration settings. As stated previously, this may be acquired dynamically from the Host Network Controller at run-time. Alternatively, it may be configured and read-in locally. The ability for a client network based QoS system to acquire its configuration dynamically, as described previously, may be via standard means (FTP, TFTP, etc) and therefore is not described in detail herein. Additionally, local storage and retrieval of the configuration may also be handled via standard means (File System, Registry, etc.) and therefore is also not described in detail herein. The initialization processing that is described in detail is that of populating the internal data structures from the configuration data however it may be acquired.

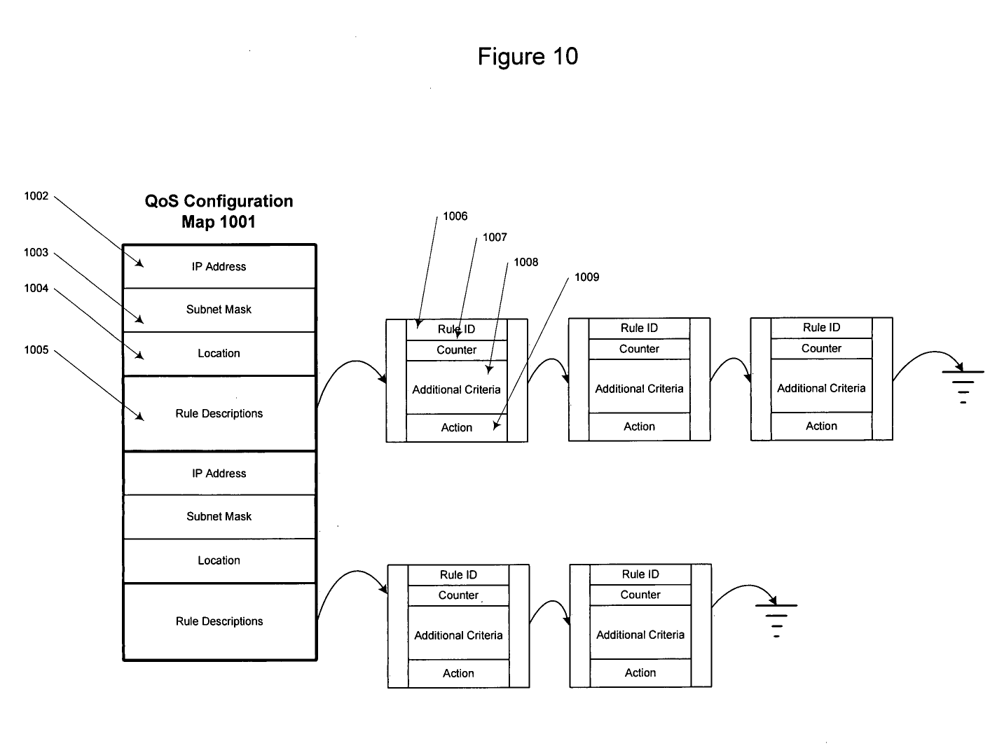

Upon startup, the network based QoS system will begin by initializing all internal data structures. There is at least a single map data structure responsible for tracking the rules created within the Network Based QoS Configuration screen 601. This structure will be initialized to be empty. After the initialization occurs, the network based QoS system will read the single configuration setting that indicates whether network based QoS processing is enabled. If it is not enabled, there is no need to continue and initialization processing terminates. If the network based QoS processing is enabled, the system will begin to read the configuration rules directly into the QoS Configuration Map 1001. An exemplary version of this data structure is depicted in FIG. 10.

While there are many different container and data model options for storing the data, FIG. 10 displays a Map data structure keyed off an IP address, subnet, and location (i.e., source/destination) combination. Therefore, for each rule created in the Network Based QoS Configuration screen 601, the initialization routine first determines the IP Address, subnet mask and location associated with the rule. These values will be stored in the IP Address 1002, Subnet Mask 1003 and Location 1004 fields within the QoS Configuration Map 1001. If the unique IP Address 1002, Subnet Mask 1003, and Location 1004 combination does not currently exist in the QoS Configuration Map 1001, then a new entry will be added to the QoS Configuration Map 1001. If the IP Address 1002, Subnet Mask 1004, and Location 1005 combination already exists, the initialization routine will not add a new record in the QoS Configuration Map 1001. In either case, the initialization will then add the rule details to the Rule Descriptions 1005 linked list that originates from the appropriate location in the QoS Configuration Map 1001.

The Rule Descriptions 1005 is a linked list that will store the individual details of the actual rule. Each entry in the linked list will have several fields:
Rule ID 1006—This field specifies a unique identifier for each rule entered in the QoS Configuration Map 1001. It is provided for functionality that may need to cross reference a rule with an entry in a database for logging or statistical purposes.
Counter 1007—This field provides a counter to provide statistical information for the rule. As the rule is accessed (i.e., packets are received that match the rule) this value will be incremented. It can provide usage statistics to the end user.
Additional Criteria 1008—This field displays the additional criteria (beyond the IP address, subnet and location) associated with the rule definition. One method for storing the information includes encoding the rule definition into a data string that can be later parsed. An example may encode a rule in a string with named value pairs:
   Rule=“IPSource=Both, Port=AII, PortSource=Both, QoSTag=2”
Action 1009—This field displays the action that is used when the packet criteria is matched. A simple method encodes the action in a named value pair similar to that described in Additional Criteria 1008.

In addition to inserting each record from persistent storage to the Map, the initialization routine will also keep track of the unique QoS values associated with any rules with the action field set to “QoS.” This counter ensures that the partner process is aware of the number of priority queues required for maintaining the priority of the data transmissions.

Once the QoS Configuration Map 1001 has been successfully populated, the network based QoS system sends the partner process a message through a standard Interprocess Communications (IPC) mechanism. This IPC message states that the network based QoS system is available.

In addition, to alerting the partner process that the network based QoS System is available, the message also alerts the process as to the number of unique outbound transmission queues that should be maintained for the QoS functionality. To effectively prioritize traffic, the system should ensure that all data with higher QoS values should be sent before data with lower QoS values. Therefore, for each QoS value, a priority transmission queue will be created. When outbound packets are to be sent, they will be placed into the appropriate outbound priority queue. Finally, the functions within the partner process responsible for sending the data will ensure that data from the highest priority queue will be sent before data from the lower priority queue(s). In an alternative embodiment, the partner process creates the maximum number of queues necessary at all times. Since the exemplary QoS processing described herein provides for only three bits of precedence values, the maximum number of priority queues is only eight. Behavior such as this may have an advantage in that it could reduce processing necessary to handle configuration changes requiring the addition or deletion of priority queues. It could also have the disadvantage of using extraneous system resources. The particular implementation would need to weigh these tradeoffs.

If any error occurred during the initialization, the partner process is notified via IPC the initialization was unsuccessful and the appropriate functionality provided by the network based QoS System will be unavailable.

Main Processing

Once the network based QoS system has been initialized, it is responsible primarily for rules processing. QoS tag propagation to the outer encapsulating packet is another task that must be performed. One embodiment provides for the partner process to perform this propagation on behalf of the network based QoS system. In this case, the network based QoS system merely indicates via IPC that this action is required. Another alternative embodiment provides for the partner process to pass all encapsulated packets back to the network based QoS system for a second pass of processing so that the network based QoS system could propagate the tags itself. A third alternative embodiment provides for the partner process to defer all calls to the network based QoS system until the packet gets encapsulated.

The preferred embodiment of having the partner process perform the propagation is further described below. The second approach has the advantage of reducing coupling, but has the disadvantage of increasing the amount of processing resources necessary to route each packet. The third approach has the advantage of minimizing coupling and limiting processing resources but reduces the flexibilities of the rules lookup to only allow actions that can be carried out after multi-network routing decisions are made. These multi-network routing decisions include those such as “Alternate” rules as described in U.S. patent application Ser. No. 10/374,070, to HOFSTAEDTER et al., filed on Feb. 27, 2003, the disclosure of which is expressly incorporated by reference herein in its entirety.

The network based QoS system will receive requests from the partner process. In one embodiment, these requests are in the form of an IPC message. In a simplistic example, the IPC message consist of at least a Type Field, Additional Information Field, Data Field and Data Length. These fields are described below:
Type Field—This field indicates whether action should be taken by the network based QoS system. The type field can be set to “No Action” or “Action Required—Type.”
Additional Information—The additional information field represents any additional data that is required to be passed between the two processes.
Data Field—This field represents the actual packet that should be processed by the network based QoS System.
Data Length—This field represents the size of the actual packet that is placed within the Data Field location in the IPC message.

All requests made of the network based QoS system by the partner process are requests for rules processing. As such, the data packet will be processed according to the rules associated with the packet. The network based QoS system begins by identifying both the source and destination IP address in the packet header. It will then look up both the source and destination IP address within the QoS Configuration Map 1001. If the entry is not found, then the network based QoS system will send an IPC message back to the partner process that contains a type field of “No Action Required.” Of course, other criteria could be designated by the rule, in which case other comparisons will occur.

The packet is first compared with all QoS entries. If the packet matches a QoS entry, in one embodiment the QoS system updates the packet's QoS tag to the designated value and then performs another lookup in the table to see if the updated packet matches criteria of non-QoS entries. If not, in one embodiment the packet is returned to the partner process with the updated QoS value and then queued by the partner process in accordance with its new QoS value. If the updated packet matches another entry in the table (i.e., a routing entry), the designated routing action is noted (e.g., default), and a response packet is generated that includes the action that should be taken with the packet.

The type field of the response packet includes the “Action Required” flag. In one embodiment, there are four types of actions:
“Alternate”—The Additional Data Field of this response lists the alternate networks that should be associated with this packet.
“Discard”—The Additional Data Field is blank in this packet.
“Default”—The Additional Data Field is blank in this response packet.
“QoS”—In some embodiments, the Additional Data Field of this response packet is set to the “QoS” value found within the Rules Based Routing Description for the matching packet.

Note that if the matching rule indicates that a “QoS” action should be taken but the packet already contains a QoS value equal to that described in the rule, this special case will translate into a “No Action Required” response. If the matching rule indicates that a “QoS” action should be taken but that the packet already contains a QoS value that is greater than that described in the rule, then a “No Action Required” response is generated. An alternative embodiment for this second condition allows for an additional configuration setting for QoS rules allowing the configured value to override (or downgrade) the QoS value to the lower value as specified in the rule.

Once the IPC packet has been created, it will then be sent back to the partner process. In addition to sending the packet back to the partner process, the application will also update the counter field within the QoS Configuration Map 1001. It increases the counter value by one to indicate that the rule has been applied to the current packet. If there are any other statistical fields within the QoS Configuration Map 1001, then these fields will be updated as well.

As with all statistical counters, the potential for numeric overflow is a possibility. The exemplary embodiment described herein may take this into account by either ensuring that the single counter field is large enough that there is reasonable assurance that such an overflow will not occur during normal extended operations or it must include a process to propagate its value to an external entity recording historical statistics and then reset itself during a period within which such an overflow is not realistically possible. The exemplary embodiment described herein makes use of the former approach by employing 64-bit counters. This approach provides for over eighteen quintillion packets to be routed before a numeric overflow occurs.

Once the packet is sent to the partner process, the partner process performs the functionality described in the “Response” packet. If the IPC message is an “Alternate” message, the partner process will identify each alternate network listed within the “Additional Data Field”. The partner process will then use this information to determine which network should be chosen for the packet, for example, based upon network availability. If the IPC message is a “Discard” message, the partner process will discard the packet. If the IPC is a “Default” message, the partner process will send the packet through the default network. Finally, if the message is a QoS message, in one embodiment the partner process will update the QoS field within the IP header of the data packet to match the appropriate value in the “Additional Data Field” entry. As noted above, in another embodiment the QoS system itself updates the QoS value and thus returns the updated packet and no data in the “Additional Data Field.”

In the preceding description, “Alternate” and “Default” route messages were passed to the partner process. The partner process then determined which network to use based upon the message. In another embodiment, the QoS system returns the actual network to be used rather than a “Default” or “Alternate” indicator. In this case, the partner process need not determine which network should be used for transmitting the packet.

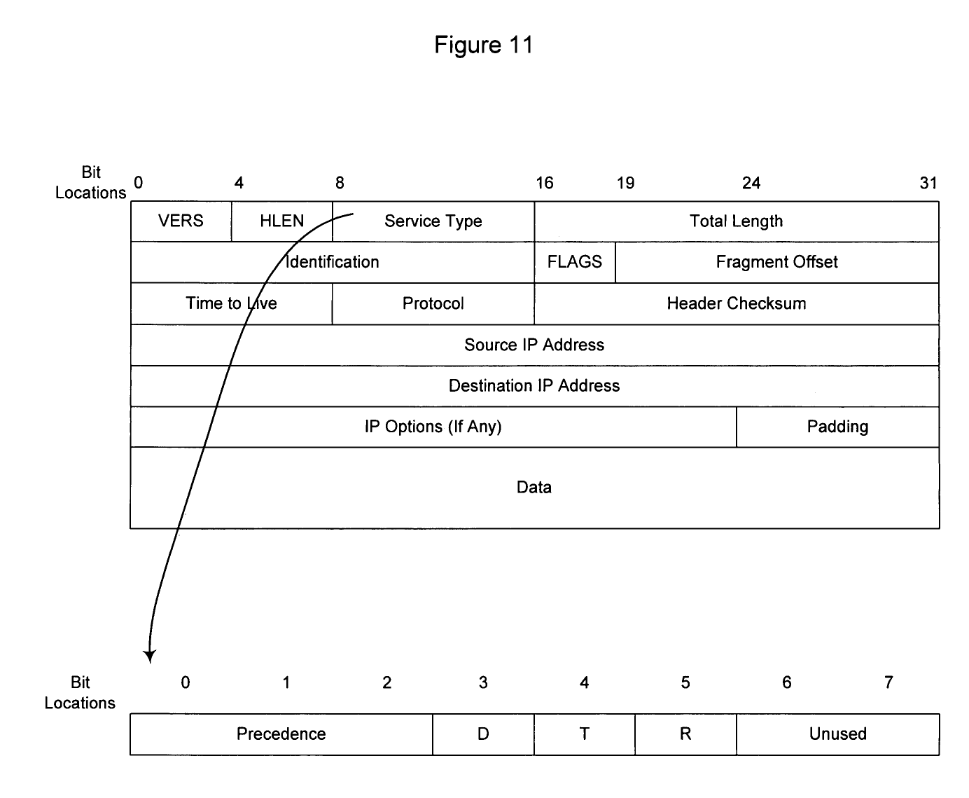

A typical location for the QoS values is shown in FIG. 11. The QoS values are normally placed within the first three bits of a Service Type field. The Service Type field always begins at the ninth bit position within the IP header. The first three bits of the Service Type field are called the Precedence. Therefore, the value that is passed to the partner process within the “Additional Data Field” section of the IPC header will be placed within the precedence field of the IP header.

Regardless of what rule is processed, anytime the partner process determines that the network based QoS system is active, any network encapsulation performed by the partner process will also propagate the original QoS value to the outer header. An alternative embodiment allows for QoS tag propagation to occur independently of the enablement of the rest of the rules-processing capabilities of the network based QoS system. Such behavior allows tag propagation to the outer encapsulating packet to occur for applications that do properly provide native QoS tagging.

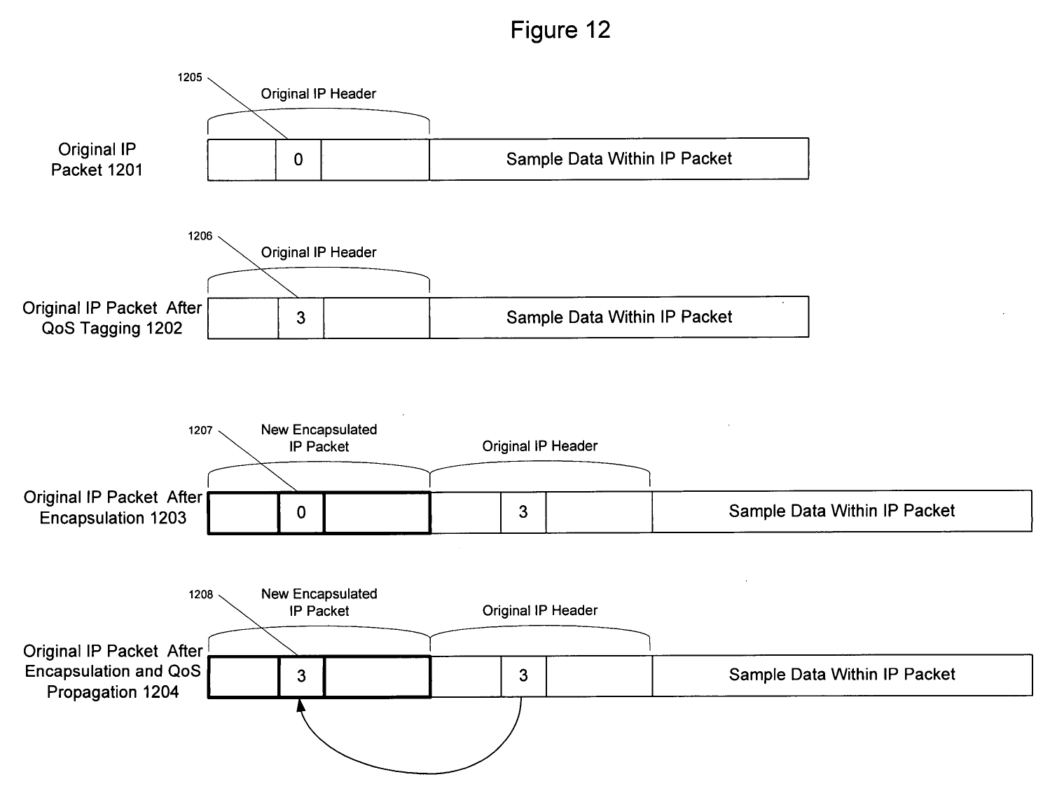

FIG. 12 shows an example of how the encapsulation process occurs. An original packet 1201 is received by the system. This packet initially has a QoS value of 0 associated with it since the precedence field 1205 is set to 0. Once the packet has been received by the system, the packet has been determined by the network based QoS system that a QoS tag of three should be associated with it, based upon the configuration. Therefore, the partner process modifies the original packet 1202 and the precedence field 1206 is now updated to three. At this point, the partner process will be responsible for performing network encapsulation. A new IP header is placed in front of the original IP packet and the resulting packet is an encapsulated packet 1203. Because most systems default the precedence bits to 0, the precedence bit will be set to 0 in this example. Finally, the partner process performs QoS propagation by copying the precedence bit from the inside IP header to the outside IP header. Therefore, the outside IP header will include the precedence bit 1208 set to three since the inner IP header has a precedence bit of three. This resulting packet 1204 is then sent through the networks.

This specification describes the ability to set the QoS field or the precedence field within the IP header. While we are specifically using IP as an example, the same framework can be used to provide the QoS setting in any type of network protocol. In addition, when using the QoS propagation, the invention can be extended to provide any generic propagation or transposition algorithms. For example, instead of just copying the precedent header from the inside to the outside, higher functionality can be provided to transpose different bytes between the inside and outside headers. One method encapsulates data from one medium to other mediums (e.g., ATM versus IP).

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium like a disk or tape; a magneto-optical or optical medium like a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for communications (e.g., IPC, FTP, TFTP, HTTP, DCOM, CORBA), Internet and other packet switched network transmission (e.g., IP version 4, IP version 6, UDP/IP, TCP/IP, ICMP), and wireless networking (802.11a, 802.11b, 802.11g, CDMA 1xRTT, CDMA 1xEVDO, GSM, CDPD, GPRS, EDGE, UMTS, RD-LAP, SMR, LMR) represent examples of the state of the art. Such standards are periodically superseded by faster or more efficient equivalents having essentially the same functions. Accordingly, replacement standards and protocols having the same functions are considered equivalents.

What is claimed:

1. A quality of service routing method operating within a system including multiple parallel dissimilar wireless networks connecting a client device and a host device, the method comprising:
selecting one of the networks based upon criteria, including priority, of a packet received from a source application; and
routing the packet between the client device and the host device across the selected network, the source application being unaware of the network selected for the packet.

2. The method of claim 1, further comprising selecting at least one other network, in addition to the first selected network, to transmit the packet based upon the packet priority.

3. The method of claim 2, further comprising routing the packet over multiple selected networks.

4. The method of claim 1, in which the selected network comprises a default network.

5. The method of claim 1, in which the selected network comprises at least one alternate network, wherein when a plurality of alternate networks are selected, the networks are listed in a priority order.

6. The method of claim 1, further comprising receiving at least one additional packet;
analyzing criteria, including priority, of the at least one additional packet; and
when the criteria matches predefined criteria, discarding the at least one additional packet without transmitting the at least one additional packet.

7. The method of claim 1, in which the criteria further comprises at least one of a port, protocol, and an IP address.

8. A method for propagating a QoS tag from an internal packet that is encapsulated by an outside packet to the outside packet, the method comprising:
determining a QoS level of the internal encapsulated packet; and
setting the QoS level in the outside packet to the QoS level determined for the internal packet.

9. A method for assigning a QoS value to a data packet based upon characteristics of the data packet, the data packet being received from a source application that operates within a system including multiple parallel dissimilar wireless networks connecting a client device and a host device, the method comprising:
determining whether the characteristics of the data packet match a user-defined criteria; and
setting a QoS level within the packet when the characteristics of the data packet match the criteria, the QoS level having been previously associated with the matched criteria by a user,
wherein, the packet is assigned the QoS level without processing by the source application.

10. A system for assigning quality of service tags to data received from a source application without processing by the source application, the system operating with dissimilar, parallel wireless networks connecting a client device and a host device, the data being routed between the client device and the host device across selected networks while the source application is unaware of the networks selected, the system comprising:
a partner process that receives data from the source application; and
a QoS system that receives data from the partner process and analyzes the data to determine whether the data matches criteria, the QoS system assigning a quality of service tag, associated with matching criteria, to the data, the QoS system returning the data and quality of service tag information to the partner process.

11. The system of claim 10, in which the criteria comprises at least one of a port, protocol, and an IP address.

12. A system for assigning quality of service tags to data received from a source application without processing by the source application, comprising:
a routing process that receives data from the source application and selects a plurality of wireless networks for transmitting the data, the wireless networks being dissimilar, parallel, and connecting a client device and a host device, the routing process routing the data between the client device and the host device across the selected networks with the source application being unaware of the networks selected; and
a QoS system that receives data from the routing process and analyzes the data to determine whether the data matches criteria, the QoS system assigning a quality of service tag, associated with matching criteria, to the data when the criteria is matched, the QoS system returning the quality of service tag information and the data to the routing process for routing.

13. The system of claim 12, in which the routing process selects the networks based upon the quality of service tag information.

14. The system of claim 12, in which the QoS system analyzes the data to determine whether the data matches criteria including the quality of service tag, the QoS system selecting at least one network for the data based upon the matching criteria, the QoS system returning the data and a network indicator to the routing process.

15. The system of claim 14, in which the routing process selects the networks based upon the network indicator.

16. A system for routing data based upon quality of service tags associated with data received from a source application, the system operating with dissimilar, parallel wireless networks connecting a client device and a host device, the data being routed between the client device and the host device across selected networks while the source application is unaware of the networks selected, the system comprising:
a partner process that receives data from the source application; and
a QoS system that receives data from the partner process and analyzes the data to determine whether the data matches criteria including a quality of service tag, the QoS system selecting at least one network for the data based upon matching criteria, the QoS system returning the data and a network indicator to the partner process.

17. The system of claim 16, in which the criteria comprises a port.

18. A system for routing data based upon quality of service tags associated with data received from a source application, comprising:
a routing system that receives data from the source application and routes the data over at least one wireless network selected based upon a network indicator associated with the data, the wireless network(s) being selected from a plurality of dissimilar, parallel wireless networks that connect a client device and a host device, the routing system routing the data between the client device and the host device across the selected network(s) while the source application remains unaware of the network(s) being used; and
a QoS system that receives data from the routing system and analyzes the data to determine whether the data matches criteria including a quality of service tag, the QoS system selecting at least one network for the data based upon matching criteria, the QoS system returning the data and the network indicator to the routing system.

19. The system of claim 18, in which the network indicator comprises a default network.

20. The system of claim 18, in which the network indicator comprises at least one alternate network, wherein when a plurality of alternate networks are indicated, the networks are listed in a priority order.

21. The system of claim 18, in which the network indicator indicates that the data is not to be sent, wherein the routing system does not send the data.
